(19) United States
(12) Patent Application Publication
(10) Pub. No.: US 2026/0313332 A1
(43) Pub. Date: Oct. 8, 2026

(54) COMMUNICATION DEVICE, COMMUNICATION SYSTEM, COMMUNICATION METHOD, AND PROGRAM

(71) Applicant: NEC Corporation, Minato-ku, Tokyo (JP)

(72) Inventors: Hideki KIKKAWA, Tokyo (JP); Takashi TONEGAWA, Tokyo (JP); Kazuki OGATA, Tokyo (JP); Yuji SATO, Tokyo (JP); Jun TAKASAWA, Tokyo (JP); Kosei KOBAYASHI, Tokyo (JP)

(73) Assignee: NEC Corporation, Minato-ku, Tokyo (JP)

(21) Appl. No.: 18/875,289

(22) PCT Filed: Jul. 20, 2022
(86) PCT No.: PCT/JP2022/028207

§ 371 Date: Dec. 16, 2024

(51) Int. Cl. H04W 4/40; G06V 10/82; G06V 20/40

(52) U.S. Cl. CPC H04W 4/40; G06V 10/82; G06V 20/46; G06V 2201/08

(57) ABSTRACT

To identify which vehicle type supporting which communication mode each vehicle is, a communication apparatus (1) includes: communication means (11) for receiving communication information and location information of a vehicle from the vehicle; video obtaining means (12) for obtaining a video of the vehicle; feature information obtaining means (13) for obtaining feature information of the vehicle based on the video obtained by the video obtaining means (12); and storage means (14) for storing, as correspondence, the feature information of the vehicle obtained by the feature information obtaining means (13) and the communication information in association with each other for each vehicle, based on the communication information, the location information, and the video of the vehicle.

### TECHNICAL FIELD

The present invention relates a communication apparatus, a communication system, a communication method, and a program.

### BACKGROUND ART

A vehicle traveling on a road is connected to a base station located in its surroundings and can connect to a network via the base station inside the cell managed by the base station. Examples of the vehicle include, for example, a vehicle that supports Uu communication such as the 5th generation mobile communication system (5G), a vehicle that supports Vehicle-to-Everything (V2X) communication (PC5 communication of LTE-V2X); a vehicle that does not support any communication, and the like, that is, there are various vehicle types supporting various communication modes on roads. As a technology related to this, there is an invention disclosed in Patent Literature 1 below.

Patent Literature 1 discloses that an information center determines whether or not it is necessary to immediately transmit information to be transmitted to the in-vehicle device, that is, the level of emergency, and then determines a communication mode of the data communication based on the determined emergency level.

### CITATION LIST

### Patent Literature

### Patent Literature 1

Japanese Patent Application Publication Tokukai No. 2007-049543

### SUMMARY OF INVENTION

### Technical Problem

In a case where a server or the like carries out information presentation to a vehicle by message transmission or the like, it is necessary to identify which vehicle type supporting which communication mode each vehicle is. However, since the technique disclosed in Patent Literature 1 is adapted to determine a communication mode of data communication based on the emergency level, even if the technique disclosed in Patent Literature 1 is applied, it is impossible to identify which vehicle type supporting which communication mode each vehicle is.

An example aspect of the present invention has been made in view of this problem, and an example object thereof is to provide a technique capable of identifying which vehicle type corresponding to which communication mode each vehicle is.

### Solution to Problem

A communication apparatus in accordance with an example aspect of the present invention includes: communication means for receiving communication information and location information of a vehicle from the vehicle; video obtaining means for obtaining a video of the vehicle; feature information obtaining means for obtaining feature information of the vehicle based on the video obtained by the video obtaining means; and storage means for storing, as correspondence, the feature information of the vehicle obtained by the feature information obtaining means and the communication information in association with each other for each vehicle, based on the communication information, the location information, and the video of the vehicle.

A communication system in accordance with an example aspect of the present invention includes: first communication means for receiving communication information and location information of a vehicle from the vehicle; first video obtaining means for obtaining a video of the vehicle; first feature information obtaining means for obtaining feature information of the vehicle based on the video obtained by the first video obtaining means; first storage means for storing, as correspondence, the feature information of the vehicle obtained by the first feature information obtaining means and the communication information in association with each other for each vehicle, based on the communication information, the location information, and the video of the vehicle; second communication means for receiving information related to the correspondence, the correspondence being stored in the first storage means and being transmitted via the first communication means; second storage means for storing the information related to the correspondence received by the second communication means; second video obtaining means for obtaining a video of the vehicle; second feature information obtaining means for obtaining feature information of the vehicle based on the video obtained by the second video obtaining means; communication information obtaining means for obtaining the communication information from the second storage means based on the feature information of the vehicle obtained by the second feature information obtaining means; and third communication means for providing information to the vehicle based on the communication information obtained by the communication information obtaining means.

A communication method in accordance with an example aspect of the present invention includes: receiving communication information and location information of a vehicle from the vehicle; obtaining a video of the vehicle; obtaining feature information of the vehicle based on the obtained video; and storing, as correspondence, the obtained feature information of the vehicle and the communication information in association with each other for each vehicle, based on the communication information, the location information, and the video of the vehicle.

A program in accordance with an example aspect of the present invention causes a computer to carry out: a process of receiving communication information and location information of a vehicle from the vehicle; a process of obtaining a video of the vehicle; a process of obtaining feature information of the vehicle based on the obtained video; and a process of storing, as correspondence, the obtained feature information of the vehicle and the communication information in association with each other for each vehicle, based on the communication information, the location information, and the video of the vehicle.

### Advantageous Effects of Invention

According to an example aspect of the present invention, it is possible to identify which vehicle type supporting which communication mode each vehicle is.

### BRIEF DESCRIPTION OF DRAWINGS

FIG. 1 is a block diagram illustrating an example configuration of a communication apparatus in accordance with a first example embodiment of the present invention.

FIG. 2 is a flowchart illustrating the flow of a communication method of the communication apparatus in accordance with the first example embodiment of the present invention.

FIG. 3 is a block diagram illustrating an example configuration of a communication system in accordance with the first example embodiment of the present invention.

FIG. 4 is a diagram for describing correspondence between feature information of a vehicle and communication information.

FIG. 5 is a flowchart illustrating the flow of a communication method of the communication system in accordance with the first example embodiment of the present invention.

FIG. 6 is a block diagram illustrating an example of an area managed by a communication apparatus in accordance with a second example embodiment of the present invention.

FIG. 7 is a block diagram illustrating an example configuration of a communication system in accordance with the second example embodiment of the present invention.

FIG. 8 is a diagram schematically illustrating a state in which a vehicle is in a second area.

FIG. 9 is a diagram schematically illustrating a state in which a vehicle enters a first area.

FIG. 10 is a block diagram illustrating the configuration of a computer that functions as each of the communication apparatus in accordance with the example embodiments of the present invention.

### EXAMPLE EMBODIMENTS

### First Example Embodiment

### Communication Apparatus 1 in Accordance with First Example Embodiment

The following description will discuss a first example embodiment of the present invention in detail with reference to the drawings. The present example embodiment is a basic form of an example embodiment described later. Note that reference signs which are indicated in the drawings and are used in this overview are given to elements for convenience as an example for assisting in understanding, and are not intended to limit the present invention to the illustrated aspects. The connection lines between blocks in the drawings and the like referred to in the descriptions below include both a bidirectional relation and a unidirectional relation. The one-way arrow schematically indicates a flow of a main signal (data), and does not exclude bidirectionality. The connection point of an input and an output of each of the blocks in the drawings may be configured to include a port or an interface. The configurations of these are not illustrated.

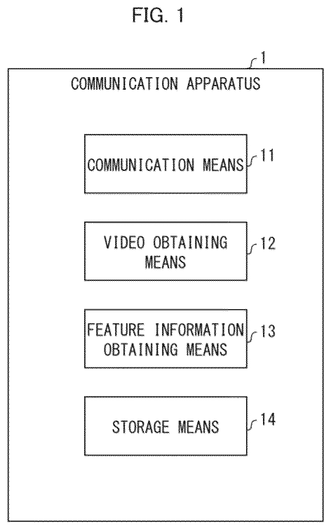

FIG. 1 is a block diagram illustrating an example configuration of a communication apparatus 1 in accordance with the first example embodiment of the present invention. As illustrated in FIG. 1, the communication apparatus 1 in accordance with the present example embodiment includes communication means 11, video obtaining means 12, feature information obtaining means 13, and storage means 14.

The communication means 11 receives communication information and location information of a vehicle from the vehicle. The communication apparatus 1 is configured to manage a predetermined area, and the communication means 11 receives the communication information and the location information from communication equipment mounted in the vehicle traveling in the predetermined area. Hereinafter, the vehicle equipped with the communication equipment is simply referred to as the “vehicle”.

The communication information of the vehicle includes at least a communication mode supported by the vehicle and address information such as the IP address of the vehicle. The communication mode may be Uu communication of 5G, PC5 communication of V2X, V2N communication, V2I communication, V2V communication, Wi-Fi (registered trademark), local 5G, or the like. C-V2X of LTE (LTE V2X) and C-V2X of 5G (NR V2X) each include two types of the communication modes, i.e., direct communication (PC5 communication) and indirect communication (Uu communication).

Uu communication is a mode for carrying out communication via a base station, which is carried out by an ordinary smartphone or the like. Here, Uu communication is unicast-type communication and may also be referred to as Vehicle-to-Network (V2N) communication.

PC5 communication is a mode in which direct communication is carried out between automobiles and between roadside facilities and automobiles without using a base station therebetween. Such types of communication may also be referred to as V2V communication and V2I communication. PC5 communication is generally broadcast-type communication and is not suitable for large-volume communication due to restrictions on bandwidth and wireless protocol specifications. Hereinafter, unless otherwise specified, the simple term “C-V2X” refers to PC5 communication.

The location information of the vehicle can be obtained by, for example, an on-board global positioning system (GPS) apparatus. The vehicle periodically obtains the location information by using the GPS apparatus and transmits the location information of the vehicle to the communication apparatus 1.

The video obtaining means 12 obtains a video of the vehicle. For example, the video obtaining means 12 may obtain a video shot with one or more cameras disposed at an intersection. The one or more cameras may shot a video of the entirety of the intersection or may shot a video of only a part of the intersection. The video obtaining means 12 may be disposed at a location other than the intersection or may be disposed in a roadside outside the intersection.

The feature information obtaining means 13 obtains feature information of the vehicle based on the video obtained by the video obtaining means 12. The feature information of the vehicle is at least one selected from the group consisting of information related to the number plate of the vehicle, information related to the model of the vehicle, information related to the shape of the vehicle, and information related to the color of the vehicle. It should be noted that the feature information of the vehicle is not limited to these types of information and only needs to be information with which the vehicle can be identified.

For example, the feature information obtaining means 13 may carry out object recognition by using deep learning such as a convolutional neural network (CNN), to identify an object in the video. For example, the feature information obtaining means 13 may be configured to identify the vehicle in the video, and also the vehicle model, shape, color thereof, and the like. The feature information obtaining means 13 may extract an image of the number plate from an image of the vehicle and obtain the information inscribed on the number plate by character recognition.

The storage means 14 stores, as correspondence, the feature information of the vehicle obtained by the feature information obtaining means 13 and the communication information in association with each other for each vehicle, based on the communication information, the location information, and the video of the vehicle. Since the vehicle the feature information of which has been obtained can be identified based on the video of the vehicle obtained by the video obtaining means 12 and the location information of the vehicle, the storage means 14 can store the feature information and the communication information of the vehicle in association with each other.

For example, there may be a case where the video obtained by the video obtaining means 12 includes a video of multiple vehicles, so that it is necessary to identify which vehicle is the vehicle the feature information of which has been obtained. In this case, the area shown in the video obtained by the video obtaining means 12 and the location information may be associated with each other in advance, and a vehicle shown in an area corresponding to the location information of the vehicle can be identified as the vehicle the feature information of which has been obtained. Thus, the storage means 14 can store, for each vehicle, the feature information of the vehicle obtained by the feature information obtaining means 13 and the communication information (received together with the location information from the vehicle) in association with each other.

Alternatively, the communication means 11 may receive communication information and feature information of a vehicle from the vehicle, and the storage means 14 may store, as correspondence, the feature information and the communication information of the vehicle in association with each other for each vehicle.

### Example Advantage of Communication Apparatus 1

As described in the foregoing, according to the communication apparatus 1 in accordance with the present example embodiment, the storage means 14 stores the feature information and the communication information of the vehicle in association with each other, so that the communication information of the vehicle can be obtained with reference to the feature information of the vehicle, and accordingly, it is possible to identify which vehicle type supporting which communication mode the vehicle is.

### Flow of Communication Method S1 Carried Out by Communication Apparatus 1

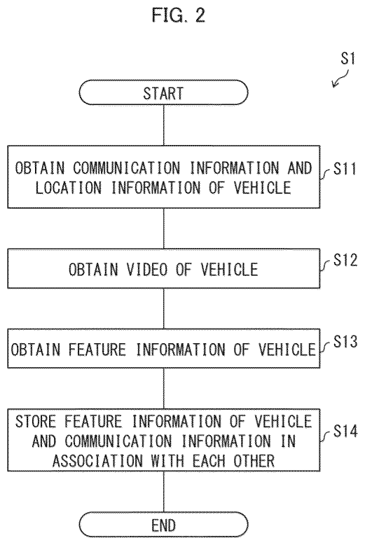

The following description will discuss the flow of a communication method carried out by the communication apparatus 1 configured as described in the foregoing, with reference to FIG. 2. FIG. 2 is a flowchart illustrating the flow of the communication method. As illustrated in FIG. 2, the communication method S1 includes steps S11 to S14.

First, the communication means 11 receives communication information and location information of a vehicle from the vehicle (S11). The communication apparatus 1 is configured to manage a predetermined area, and the communication means 11 receives the communication information and the location information from the vehicle traveling in the predetermined area.

Next, the video obtaining means 12 obtains a video of the vehicle (S12). For example, the video obtaining means 12 may obtain a video shot with one or more cameras disposed at an intersection. The one or more cameras may shot a video of the entirety of the intersection or may shot a video of only a part of the intersection.

Next, the feature information obtaining means 13 obtains feature information of the vehicle based on the video obtained by the video obtaining means 12 (S13). The feature information of the vehicle is at least one selected from the group consisting of information related to the number plate of the vehicle, information related to the model of the vehicle, information related to the shape of the vehicle, and information related to the color of the vehicle.

Finally, the storage means 14 stores, as correspondence, the feature information of the vehicle obtained by the feature information obtaining means 13 and the communication information of the vehicle in association with each other for each vehicle, based on the communication information, the location information, and the video of the vehicle (S14). Since the vehicle the feature information of which has been obtained can be identified based on the video of the vehicle obtained by the video obtaining means 12 and the location information of the vehicle as described above, the storage means 14 can store the feature information of the vehicle and the communication information in association with each other.

### Example Advantage of Communication Method S1

As described in the foregoing, according to the communication method S1 of the communication apparatus 1 in accordance with the present example embodiment, the storage means 14 stores the feature information and the communication information of the vehicle in association with each other, so that the communication information of the vehicle can be obtained with reference to the feature information of the vehicle, and accordingly, it is possible to identify which vehicle type supporting which communication mode the vehicle is.

### Communication System 100 in Accordance with First Example Embodiment

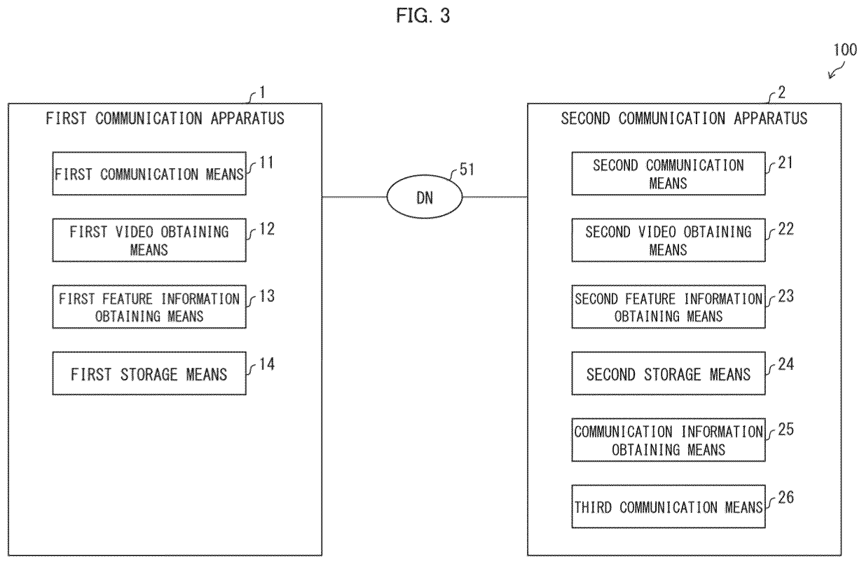

FIG. 3 is a block diagram illustrating an example configuration of a communication system 100 in accordance with the first example embodiment of the present invention. As illustrated in FIG. 3, the communication system 100 in accordance with the present example embodiment has a configuration in which a first communication apparatus 1 and a second communication apparatus 2 are connected via a data network (DN) 51.

Although a specific configuration of the DN 51 is not intended to limit the present example embodiment, examples of the network may include a wireless local area network (LAN), a wired LAN, a wide area network (WAN), a public network, a mobile data communication network, and a combination of these networks.

The first communication apparatus 1 includes first communication means 11, first video obtaining means 12, first feature information obtaining means 13, and first storage means 14. The second communication apparatus 2 includes second communication means 21, second video obtaining means 22, second feature information obtaining means 23, second storage means 24, communication information obtaining means 25, and third communication means 26. Here, the second communication means 21 and the third communication means 26 may be identical.

The functions of the first communication apparatus 1 and the second communication apparatus 2 may be implemented in a cloud or on multi-access edge computing (MEC). For example, the first communication means 11 and the first video obtaining means 12 of the first communication apparatus 1 may constitute a single apparatus, or alternatively, the first feature information obtaining means 13 and the first storage means 14 may constitute a single apparatus. These may be implemented in a single apparatus or in separate apparatuses. For example, if these functions are implemented in separate apparatuses, information of each section is transmitted and received via the DN 51 for processing.

The first communication means 11 receives communication information and location information of a vehicle from the vehicle. The first communication apparatus 1 is configured to manage a first area, and the first communication means 11 receives the communication information and the location information from the vehicle traveling in the first area. The communication information of the vehicle includes at least a communication mode supported by the vehicle and address information of the vehicle. As an example, a vehicle traveling in the first area transmits the communication information to the first communication means 11 in order to obtain surrounding traffic information and the like. The first communication means 11 transmits the surrounding traffic information and the like to the vehicle traveling in the first area by using the communication information transmitted. At this time, the vehicle traveling in the first area also transmits the location information to the first communication means 11.

The first video obtaining means 12 obtains a video of the vehicle. For example, the video obtaining means 12 may obtain a video of the first area shot with one or more cameras disposed at an intersection in the first area. The one or more cameras may shot a video of the entirety of the intersection or may shot a video of only a part of the intersection.

The first feature information obtaining means 13 obtains feature information of the vehicle based on the video obtained by the video obtaining means 12. The feature information of the vehicle is at least one selected from the group consisting of information related to the number plate of the vehicle, information related to the model of the vehicle, information related to the shape of the vehicle, and information related to the color of the vehicle.

The first storage means 14 stores, as correspondence, the feature information of the vehicle obtained by the first feature information obtaining means 13 and the communication information of the vehicle in association with each other for each vehicle, based on the communication information, the location information, and the video of the vehicle. Since the vehicle the feature information of which has been obtained can be identified based on the video of the vehicle obtained by the first video obtaining means 12 and the location information of the vehicle, the first storage means 14 can store the feature information of the vehicle and the communication information in association with each other. As an example, in a case where the location information received from the vehicle coincides with or approximates to the location information of one or more cameras disposed at the intersection in the first area, the first storage means 14 recognizes that the vehicle from which the communication information has been transmitted and the vehicle shot with the one or more cameras disposed at the intersection in the first area are the identical vehicle, and the first storage means 14 stores, as correspondence, the feature information of the vehicle obtained by the first feature information obtaining means 13 and the communication information in association with each other for each vehicle. In this case, instead of using the location information of the one or more cameras disposed at the intersection in the first area, the location information of the first area in which the one or more cameras are disposed or the location information in an area shot with the one or more cameras may be used.

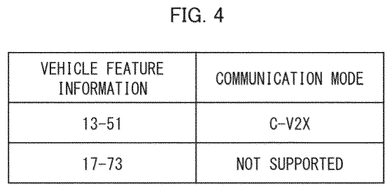

FIG. 4 is a diagram for describing correspondence between feature information and communication information (communication mode) of a vehicle. In FIG. 4, information related to the number plate of a vehicle is shown as the feature information of the vehicle, and the communication mode of the vehicle is shown as the communication information of the vehicle. FIG. 4 shows that, regarding a vehicle having the feature information of “13-51”, the communication mode supported by the vehicle is “C-V2X”. FIG. 4 also shows that, regarding a vehicle having the feature information of “17-73”, the vehicle supports neither “C-V2X” nor “Uu communication”.

The first communication means 11 retrieves the information related to the correspondence stored in the first storage means 14 (i.e., the feature information and the communication information of the vehicle), and transmits the information related to the correspondence to the second communication apparatus 2 via the DN 51.

The second communication means 21 receives the information related to the correspondence, which is stored in the first storage means 14 and is transmitted via the first communication means 11. This information related to the correspondence includes the feature information of the vehicle and the communication information of the vehicle, as shown in FIG. 4.

The second storage means 24 stores the information related to the correspondence received by the second communication means 21. At this time, the second storage means 24 stores the feature information of the vehicle and the communication information of the vehicle, which are included in the information related to the correspondence, in association with each other.

The second video obtaining means 22 obtains a video of the vehicle. The second communication apparatus 2 is configured to manage a second area, and the second video obtaining means 22 may obtain, for example, a video of the second area shot with one or more cameras disposed at an intersection in the second area.

The second feature information obtaining means 23 obtains the feature information of the vehicle based on the video obtained by the second video obtaining means 22. Here, this vehicle is the vehicle that has moved from the first area to the second area, and the feature information and the communication information of the vehicle have already been stored in association with each other in the second storage means 24.

The communication information obtaining means 25 obtains the communication information from the second storage means 24 based on the feature information of the vehicle obtained by the second feature information obtaining means 23. Since the feature information and the communication information of the vehicle have already been stored in association with each other in the second storage means 24 as described above, the communication information obtaining means 25 can obtain the communication information of the vehicle with reference to the feature information of the vehicle.

The third communication means 26 provides information to the vehicle based on the communication information obtained by the communication information obtaining means 25. Since the communication information of the vehicle includes the communication mode of the vehicle and the address information of the vehicle, the third communication means 26 can use these pieces of information to start providing information to the vehicle immediately after the vehicle enters the second area.

### Example Advantage of Communication System 100

As described in the foregoing, according to the communication system 100 in accordance with the present example embodiment, the communication information obtaining means 25 obtains the communication information from the second storage means 24 based on the feature information of the vehicle obtained by the second feature information obtaining means 23. Thus, the third communication means 26 can start providing information immediately after the vehicle enters the second area.

For example, if the vehicle supports C-V2X, the third communication means 26 may provide information to the vehicle by means of the broadcast communication of C-V2X. In this case, the address information of the vehicle is not required. Further, if the vehicle supports Uu communication, the third communication means 26 can use the address information of the vehicle to provide information to the vehicle by means of Uu communication.

### Flow of Communication Methods S1 and S2 Carried Out by Communication System 100

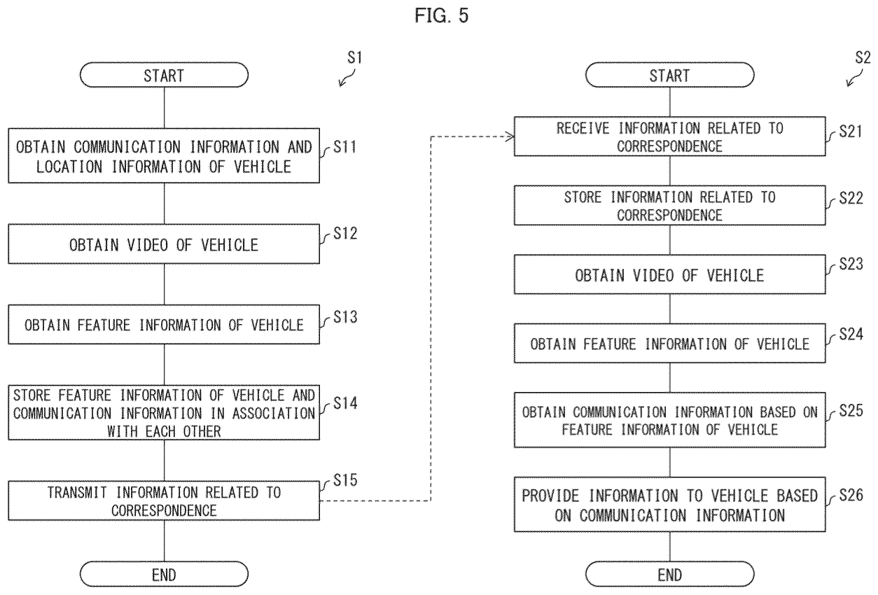

The following description will discuss the flow of a communication method carried out by the communication system 100 configured as described in the foregoing, with reference to FIG. 5. FIG. 5 is a flowchart illustrating the flow of the communication method. As illustrated in FIG. 5, the communication method S1 includes S11 to S15, and the S2 includes steps S21 to S26. The S1 is mainly a process flow carried out by the first communication apparatus 1, and the S2 is mainly a process flow carried out by the second communication apparatus 2.

First, the first communication means 11 receives communication information and location information of a vehicle from the vehicle (S11). The first communication apparatus 1 is configured to manage a first area, and the first communication means 11 receives the communication information and the location information from the vehicle traveling in the first area. The communication information of the vehicle includes at least a communication mode supported by the vehicle and address information of the vehicle.

Next, the first video obtaining means 12 obtains a video of the vehicle (S12). For example, the video obtaining means 12 may obtain a video of the first area shot with one or more cameras disposed at an intersection in the first area.

Next, the first feature information obtaining means 13 obtains feature information of the vehicle based on the video obtained by the first video obtaining means 12 (S13). The feature information of the vehicle is at least one selected from the group consisting of information related to the number plate of the vehicle, information related to the model of the vehicle, information related to the shape of the vehicle, and information related to the color of the vehicle.

Next, the first storage means 14 stores, as correspondence, the feature information of the vehicle obtained by the first feature information obtaining means 13 and the communication information in association with each other for each vehicle, based on the communication information, the location information, and the video of the vehicle (S14).

Then, the first communication means 11 retrieves the information related to the correspondence stored in the first storage means 14 (i.e., the feature information and the communication information of the vehicle), and transmits the information related to the correspondence to the second communication apparatus 2 via the DN 51 (S15).

On the other hand, in the second communication apparatus 2 configured to manage the second area, the second communication means 21 receives the information related to the correspondence, which is stored in the first storage means 14 and is transmitted via the first communication means 11 (S21). This information related to the correspondence includes the feature information of the vehicle and the communication information of the vehicle.

Next, the second storage means 24 stores the information related to the correspondence received by the second communication means 21 (S22). At this time, the second storage means 24 stores the feature information of the vehicle and the communication information of the vehicle, which are included in the information related to the correspondence, in association with each other.

Next, the second video obtaining means 22 obtains a video of the vehicle (S23). For example, the second video obtaining means 22 may obtain a video of the second area shot with one or more cameras disposed at an intersection in the second area.

Next, the second feature information obtaining means 23 obtains the feature information of the vehicle based on the video obtained by the second video obtaining means 22 (S24). Here, this vehicle is the vehicle that has moved from the first area to the second area, and the feature information and the communication information of the vehicle have already been stored in association with each other in the second storage means 24.

Next, the communication information obtaining means 25 obtains the communication information from the second storage means 24 based on the feature information of the vehicle obtained by the second feature information obtaining means 23. Since the feature information and the communication information of the vehicle have already been stored in association with each other in the second storage means 24 as described above, the communication information obtaining means 25 can obtain the communication information of the vehicle with reference to the feature information of the vehicle.

Finally, the third communication means 26 provides information to the vehicle based on the communication information obtained by the communication information obtaining means 25. Since the communication information of the vehicle includes the communication mode of the vehicle and the address information of the vehicle, the third communication means 26 can use these pieces of information to start providing information immediately after the vehicle enters the second area.

### Example Advantage of Communication Methods S1 and S2 Carried Out by Communication System 100

As described in the foregoing, according to the communication method of the communication system 100 in accordance with the present example embodiment, the communication information obtaining means 25 obtains the communication information from the second storage means 24 based on the feature information of the vehicle obtained by the second feature information obtaining means 23. Thus, the third communication means 26 can start providing information immediately after the vehicle enters the second area.

### Second Example Embodiment

### Example Configuration of Communication System 100A in Accordance with Second Example Embodiment

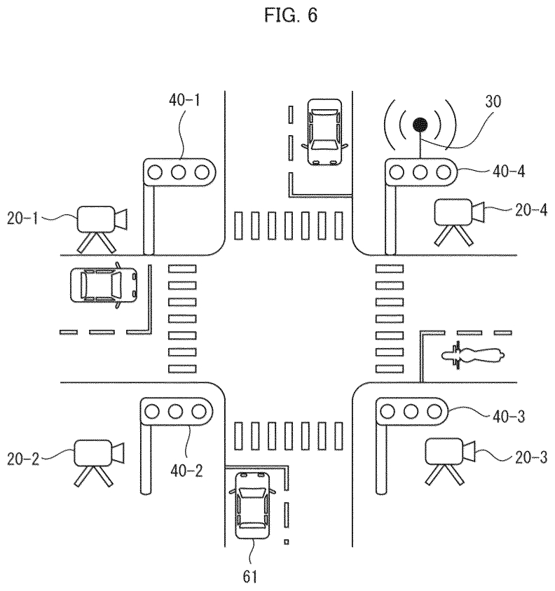

FIG. 6 is a block diagram illustrating an example of an area managed by a communication apparatus in accordance with a second example embodiment of the present invention. As illustrated in FIG. 6, four traffic lights 40-1 to 40-4 are installed at the intersection. The traffic lights 40-1 to 40-4 are provided with respective cameras 20-1 to 20-4. The traffic light 40-4 is also provided with a base station 30.

For example, the communication apparatus may obtain a video from the camera 20-1 and analyze the video showing only a part of the intersection, or alternatively, the communication apparatus may obtain four videos from the respective cameras 20-1 to 20-4 to analyze the videos showing the entirety of the intersection.

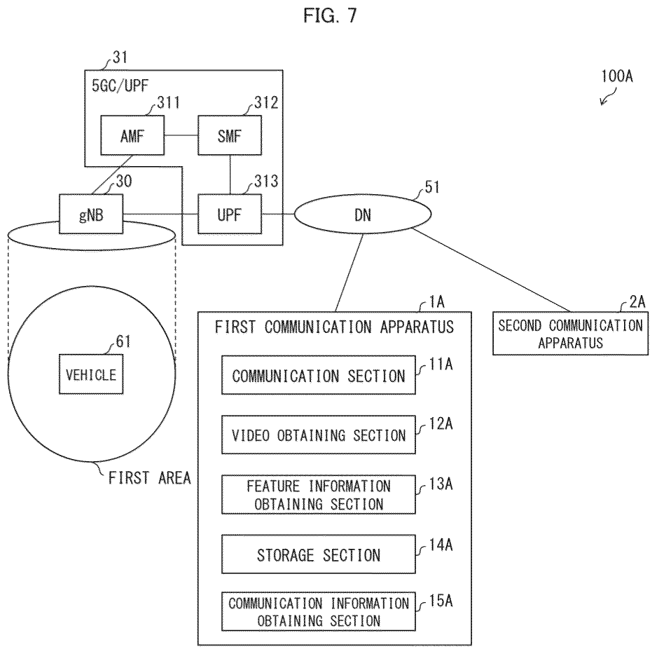

FIG. 7 is a diagram illustrating the configuration of a communication system 100A in accordance with the second example embodiment of the present invention. The communication system 100A in accordance with the present example embodiment includes a first communication apparatus 1A, a second communication apparatus 2A, a base station (gNB) 30, a 5GC/UPF 31, and a DN 51.

The base station 30 may support, for example, the gNB in 5GC or 4GC. The connection between the 5GC/UPF 31 and a vehicle 61 is carried out via the base station (gNB) 30. The first communication apparatus 1A, the second communication apparatus 2A, and the 5GC/UPF 31 are connected to the DN 51. The DN 51 is a data network outside of 5GC or 4GC, and includes a wide area network, such as the internet, and a narrow area network, such as the LAN.

The 5GC/UPF 31 includes an access and mobility function (AMF) 311, a session management function (SMF) 312, and a user plane function (UPF) 313.

The AMF 311 is a network function (NF) that provides authentication, permission, mobility management, and the like of the vehicle (UE) 61 and controls the SMF 312. The SMF 312 is an NF which is responsible for session management of the vehicle 61, assignment of an IP address, selection and control of the UPF 313 for data transfer, and the like.

For example, in a case where the vehicle 61 establishes a plurality of sessions, the AMF 311 may assign different SMFs 312 to respective sessions so that the SMF 312 independently manages each session and utilizes different functions for each session. In 5GC, for example, the management related to the vehicle 61 is carried out by a single AMF 311, and traffic is handled by the SMF 312 for each individual network slice.

In 5GC, employed is architecture in which the control plane (C-Plane) for control-signal communication, such as establishment of communication, and the user plane (U-Plane) for user data communication are processed separately. The C-Plane includes the AMF 311, the SMF 312, and the like. The U-Plane includes the UPF 313.

The UPF 313 serves as an external protocol data unit (PDU) session point for interconnections to the DN 51, and the UPF 313 is an NF that carries out packet routing, forwarding, and the like.

The first communication apparatus 1A is configured to manage a first area, and includes a communication section 11A, a video obtaining section 12A, a feature information obtaining section 13A, a storage section 14A, and a communication information obtaining section 15A. It should be noted that the configuration of the second communication apparatus 2A configured to manage the second area is similar to that of the first communication apparatus 1A.

The communication section 11A has a configuration for implementing the communication means in the present example embodiment. The video obtaining section 12A has a configuration for implementing the video obtaining means in the present example embodiment. The feature information obtaining section 13A has a configuration for implementing the feature information obtaining means in the present example embodiment. The storage section 14A has a configuration for implementing the storage means in the present example embodiment. The communication information obtaining section 15A has a configuration for implementing the communication information obtaining means in the present example embodiment.

The communication section 11A receives communication information and location information of the vehicle 61, from the vehicle 61. The communication information includes a communication mode supported by the vehicle 61. The communication information may include address information of the vehicle 61.

The video obtaining section 12A obtains a video of the vehicle 61. The feature information obtaining section 13A obtains the feature information of the vehicle 61 based on the video obtained by the video obtaining section 12A. The storage section 14A stores, as correspondence, the feature information of the vehicle 61 obtained by the feature information obtaining section 13A and the communication information in association with each other for each vehicle, based on the communication information, the location information, and the video of the vehicle 61. The feature information of the vehicle 61 is at least one selected from the group consisting of information related to the number plate of the vehicle 61, information related to the model of the vehicle 61, information related to the shape of the vehicle 61, and information related to the color of the vehicle 61.

The first communication apparatus 1A is configured to manage a first area. The communication section 11A receives information related to the correspondence from the second communication apparatus 2A configured to manage the second area, and stores the received information in the storage section 14A. The first communication apparatus 1A also transmits the information related to the correspondence obtained by the first communication apparatus 1A itself to the second communication apparatus 2A.

The communication information obtaining section 15A obtains the communication information from the storage section 14A based on the feature information of the vehicle 61 obtained by the feature information obtaining section 13A. The communication information obtaining section 15A may obtain the communication information from the storage section 14A by using the information related to the correspondence obtained by the first communication apparatus 1A itself, or alternatively, the communication information obtaining section 15A may obtain the communication information from the storage section 14A by using the information related to the correspondence which has been received from the second communication apparatus 2A and has been stored in the storage section 14A.

The communication section 11A provides information to the vehicle 61 based on the communication information obtained by the communication information obtaining section 15A. Since the communication information of the vehicle 61 includes the communication mode of the vehicle 61 and the address information of the vehicle 61, the communication section 11A can use these pieces of information to start providing information immediately after the vehicle 61 enters the first area from the second area.

It should be noted that in a case where the vehicle 61 supporting C-V2X is in an area in which C-V2X cannot be used, another means provided in the area, such as a method of notifying the vehicle 61 by means of an electronic bulletin board, may be employed.

Further, the first communication apparatus 1A can communicate with the vehicle 61 as long as the IP address is known even if the communication mode of the vehicle 61 is not known. However, by making the first communication apparatus 1A ascertain the communication mode of the vehicle 61, it is possible to prevent, for example, the first communication apparatus 1A from making an attempt to carry out communication in the C-V2X mode with the vehicle 61 that does not support C-V2X, resulting in a decrease in waste of resources.

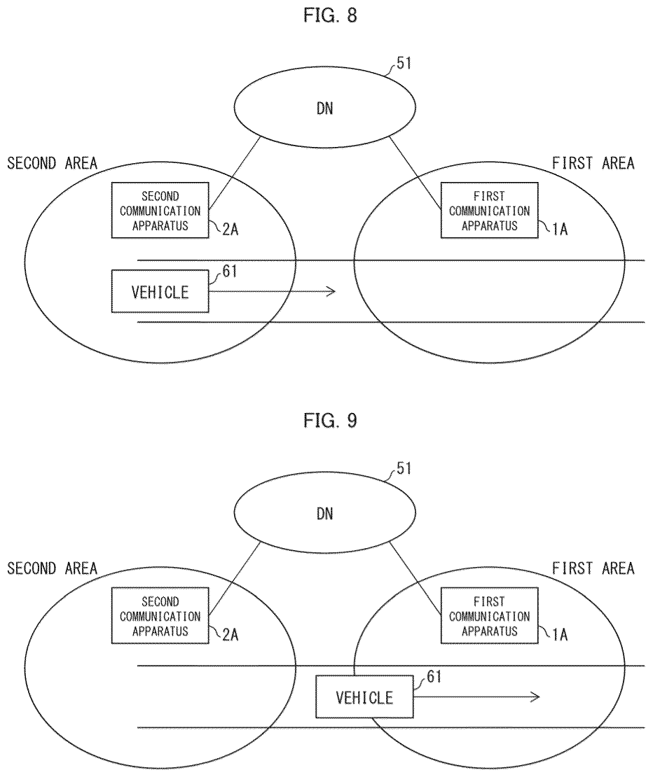

FIG. 8 is a diagram schematically illustrating a state in which the vehicle 61 is in the second area. In a case where the vehicle 61 is in the second area, the second communication apparatus 2A obtains information related to the correspondence of the vehicle 61 (feature information of the vehicle 61 and communication information of the vehicle 61) and transmits the information to the first communication apparatus 1A.

The first communication apparatus 1A receives, from the second communication apparatus 2A, information related to the correspondence of the vehicle 61 (feature information of the vehicle 61 and communication information of the vehicle 61), and stores the feature information of the vehicle 61 and the communication information of the vehicle 61 in association with each other in the storage section 14A.

FIG. 9 is a diagram schematically illustrating a state in which the vehicle 61 enters the first area. Upon entry of the vehicle 61 into the first area, the feature information obtaining section 13A of the first communication apparatus 1A obtains feature information of the vehicle 61 based on a video obtained by the video obtaining section 12A.

The communication information obtaining section 15A obtains the communication information from the storage section 14A based on the feature information of the vehicle 61 obtained by the feature information obtaining section 13A. Accordingly, the communication section 11A can provide information to the vehicle 61 based on the communication information obtained by the communication information obtaining section 15A.

### Example Advantage of First Communication Apparatus 1A

As describe in the foregoing, according to the first communication apparatus 1A in accordance with the present example embodiment, the communication section 11A receives the information related to the correspondence from the second communication apparatus 2A configured to manage the second area and stores the received information in the storage section 14A. Therefore, the first communication apparatus 1A can share the information related to the correspondence with the second communication apparatus 2A configured to manage the second area.

Further, the communication information obtaining section 15A obtains the communication information from the storage section 14A based on the feature information of the vehicle 61 obtained by the feature information obtaining section 13A. Therefore, the communication information obtaining section 15A can obtain the communication information of the vehicle 61 that has moved from the second area to the first area only by referring to the storage section 14A.

Further, the communication section 11A provides information to the vehicle 61 based on the communication information obtained by the communication information obtaining section 15A. Therefore, the communication section 11A can provide the information in the communication mode supported by the vehicle 61.

### Software Implementation Example

Some or all of the functions of each of the first communication apparatuses 1 and 1A, the second communication apparatuses 2 and 2A, and the communication systems 100 and 100A may be implemented by hardware such as an integrated circuit (IC chip), or may be alternatively implemented by software.

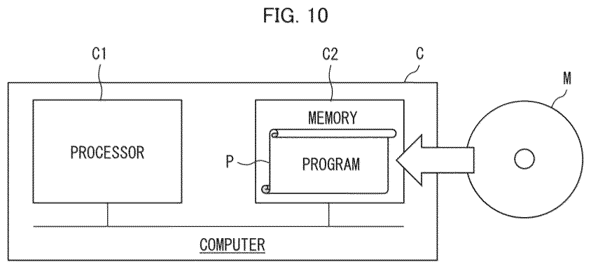

In the latter case, the first communication apparatuses 1 and 1A, the second communication apparatuses 2 and 2A, and the communication systems 100 and 100A are implemented by, for example, a computer that executes instructions of a program that is software implementing the foregoing functions. FIG. 10 illustrates an example of such a computer (hereinafter, referred to as “computer C”). The computer C includes at least one processor C1 and at least one memory C2. The memory C2 stores a program P for causing the computer C to operate as each of the first communication apparatuses 1 and 1A, the second communication apparatuses 2 and 2A, and the communication systems 100 and 100A. The processor C1 of the computer C retrieves the program P from the memory C2 and executes the program P, so that the functions of the first communication apparatuses 1 and 1A, the second communication apparatuses 2 and 2A, and the communication systems 100 and 100A are implemented.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a microcontroller, or a combination of these. The memory C2 can be, for example, a flash memory, a hard disk drive (HDD), a solid state drive (SSD), or a combination of these.

Note that the computer C may further include a RAM in which the program P is loaded in execution of the program P and/or in which various kinds of data are temporarily stored. The computer C may further include a communication interface via which data is transmitted to and received from another apparatus. The computer C may further include an input/output interface for connecting input/output apparatuses such as a keyboard, a mouse, a display and a printer.

The program P can be stored in a non-transitory tangible storage medium M which is readable by the computer C. The storage medium M can be, for example, a tape, a disk, a card, a semiconductor memory, a programmable logic circuit, or the like. The computer C can acquire the program P via the storage medium M. The program P can be transmitted via a transmission medium. The transmission medium can be, for example, a communications network, a broadcast wave, or the like. The computer C can obtain the program P also via such a transmission medium.

### Additional Remark 1

The present invention is not limited to the above example embodiments, but may be altered in various ways by a skilled person within the scope of the claims. For example, the present invention also encompasses, in its technical scope, any example embodiment derived by appropriately combining technical means disclosed in the foregoing example embodiments.

### Additional Remark 2

Some of or all of the foregoing example embodiments can also be described as below. Note, however, that the present invention is not limited to the following supplementary notes.

### Supplementary Note 1

A communication apparatus including:
communication means for receiving communication information and location information of a vehicle from the vehicle;
video obtaining means for obtaining a video of the vehicle;
feature information obtaining means for obtaining feature information of the vehicle based on the video obtained by the video obtaining means; and
storage means for storing, as correspondence, the feature information of the vehicle obtained by the feature information obtaining means and the communication information in association with each other for each vehicle, based on the communication information, the location information, and the video of the vehicle.

With this configuration, it is possible to obtain the communication information of the vehicle with reference to the feature information of the vehicle, to identify which vehicle type supporting which communication mode the vehicle is.

### Supplementary Note 2

The communication apparatus according to Supplementary note 1, wherein the communication information includes a communication mode supported by the vehicle.

### Supplementary Note 3

The communication apparatus according to Supplementary note 1 or 2, wherein the communication information includes address information of the vehicle.

### Supplementary Note 4

The communication apparatus according to any one of Supplementary notes 1 to 3, wherein the feature information of the vehicle is at least one selected from the group consisting of information related to a number plate of the vehicle, information related to a model of the vehicle, information related to a shape of the vehicle, and information related to a color of the vehicle.

### Supplementary Note 5

The communication apparatus according to any one of Supplementary notes 1 to 4, wherein
the communication apparatus is configured to manage a first area, and
the communication means receives information related to the correspondence from another communication apparatus configured to manage a second area and stores the received information in the storage means, the another communication apparatus being other than the communication apparatus configured to manage the first area.

This configuration enables the communication apparatus to share information related to the correspondence with another communication apparatus that manages the second area.

### Supplementary Note 6

The communication apparatus according to any one of Supplementary notes 1 to 5, further including communication information obtaining means for obtaining the communication information from the storage means based on the feature information of the vehicle obtained by the feature information obtaining means,
wherein the communication means provides information to the vehicle based on the communication information obtained by the communication information obtaining means.

This configuration enables the communication information obtaining means to obtain the communication information of the vehicle that has moved from the second area to the first area only by referring to the storage means. Further, the communication means can provide information in the communication mode supported by the vehicle.

### Supplementary Note 7

A communication system including:
first communication means for receiving communication information and location information of a vehicle from the vehicle;
first video obtaining means for obtaining a video of the vehicle;
first feature information obtaining means for obtaining feature information of the vehicle based on the video obtained by the first video obtaining means;
first storage means for storing, as correspondence, the feature information of the vehicle obtained by the first feature information obtaining means and the communication information in association with each other for each vehicle, based on the communication information, the location information, and the video of the vehicle;
second communication means for receiving information related to the correspondence, the correspondence being stored in the first storage means and being transmitted via the first communication means;
second storage means for storing the information related to the correspondence received by the second communication means;
second video obtaining means for obtaining a video of the vehicle;
second feature information obtaining means for obtaining feature information of the vehicle based on the video obtained by the second video obtaining means;
communication information obtaining means for obtaining the communication information from the second storage means based on the feature information of the vehicle obtained by the second feature information obtaining means; and
third communication means for providing information to the vehicle based on the communication information obtained by the communication information obtaining means.

With this configuration, it is possible to obtain the communication information of the vehicle with reference to the feature information of the vehicle, to identify which vehicle type supporting which communication mode the vehicle is.

### Supplementary Note 8

A communication method including:
receiving communication information and location information of a vehicle from the vehicle;
obtaining a video of the vehicle;
obtaining feature information of the vehicle based on the obtained video; and
storing, as correspondence, the obtained feature information of the vehicle and the communication information in association with each other for each vehicle, based on the communication information, the location information, and the video of the vehicle.

With this configuration, it is possible to obtain the communication information of the vehicle with reference to the feature information of the vehicle, to identify which vehicle type supporting which communication mode the vehicle is.

### Supplementary Note 9

A program for causing a computer to carry out:
a process of receiving communication information and location information of a vehicle from the vehicle;
a process of obtaining a video of the vehicle;
a process of obtaining feature information of the vehicle based on the obtained video; and
a process of storing, as correspondence, the obtained feature information of the vehicle and the communication information in association with each other for each vehicle, based on the communication information, the location information, and the video of the vehicle.

With this configuration, it is possible to obtain the communication information of the vehicle with reference to the feature information of the vehicle, to identify which vehicle type supporting which communication mode the vehicle is.

### Supplementary Note 10

A communication apparatus including at least one processor, the at least one processor carrying out:
a process of receiving communication information and location information of a vehicle from the vehicle;
a process of obtaining a video of the vehicle;
a process of obtaining feature information of the vehicle based on the obtained video; and
a process of storing, as correspondence, the obtained feature information of the vehicle and the communication information in association with each other for each vehicle, based on the communication information, the location information, and the video of the vehicle.

It should be noted that this communication apparatus may further include a memory, which may store therein a program for causing the at least one processor to carry out the reception process, the process of obtaining a video, the process of obtaining feature information, and the storage process. Alternatively, the program may be stored in a computer-readable, non-transitory, tangible storage medium.

### REFERENCE SIGNS LIST

1, 1A Communication apparatus (first communication apparatus)
2, 2A Second communication apparatus
11 Communication means (first communication means)
11A Communication section
12 Video obtaining means (first video obtaining means)
12A Video obtaining section
13 Feature information obtaining means (first feature information obtaining means)
13A Feature information obtaining section
14 Storage means (first communication means)
14A Storage section
15A Communication information obtaining section
20 Camera
21 Second communication means
22 Second video obtaining means
23 Second feature information obtaining means
24 Second storage means
25 Communication information obtaining means
26 Third communication means
30 Base station (gNB)
31 5GC/UPF
40 Traffic light
51 DN
61 Vehicle
100, 100A Communication system
311 AMF
312 SMF
313 UPF

What is claimed is:

1. A communication apparatus comprising at least one processor, the at least one processor carrying out:
a process of receiving communication information and location information of a vehicle from the vehicle;
a process of obtaining a video of the vehicle;
a process of obtaining feature information of the vehicle based on the obtained video; and
a process of storing, in a storage section, as correspondence, the obtained feature information of the vehicle and the communication information in association with each other for each vehicle, based on the communication information, the location information, and the video of the vehicle.

2. The communication apparatus according to claim 1, wherein the communication information includes a communication mode supported by the vehicle.

3. The communication apparatus according to claim 2, wherein the communication information includes address information of the vehicle.

4. The communication apparatus according to claim 1, wherein the feature information of the vehicle is at least one selected from the group consisting of information related to a number plate of the vehicle, information related to a model of the vehicle, information related to a shape of the vehicle, and information related to a color of the vehicle.

5. The communication apparatus according to claim 1, wherein
the communication apparatus is configured to manage a first area, and
in the process of receiving, the at least one processor receives information related to the correspondence from another communication apparatus configured to manage a second area and stores the received information in the storage section, the another communication apparatus being other than the communication apparatus configured to manage the first area.

6. The communication apparatus according to claim 5, wherein the at least one processor further carries out:
a process of obtaining the communication information from the storage section based on the obtained feature information of the vehicle, and
a process of providing information to the vehicle based on the obtained communication information.

7. A communication system comprising at least one processor, the at least one processor carrying out:
a process of receiving communication information and location information of a vehicle from the vehicle;
a process of obtaining a first video of the vehicle;
a process of obtaining first feature information of the vehicle based on the first video;
a process of storing, in a first storage section, as correspondence, the first feature information of the vehicle and the communication information in association with each other for each vehicle, based on the communication information, the location information, and the first video of the vehicle;
a process of receiving information related to the correspondence stored in the first storage section;
a process of storing, in a second storage section, the received information related to the correspondence;
a process of obtaining a second video of the vehicle;
a process of obtaining second feature information of the vehicle based on the second video;
a process of obtaining the communication information from the second storage section based on the second feature information of the vehicle; and
a process of providing information to the vehicle based on the communication information.

8-9. (canceled)

10. The communication system according to claim 7, wherein the communication information includes a communication mode supported by the vehicle.

11. The communication system according to claim 10, wherein the communication information includes address information of the vehicle.

12. The communication system according to claim 7, wherein the feature information of the vehicle is at least one selected from the group consisting of information related to a number plate of the vehicle, information related to a model of the vehicle, information related to a shape of the vehicle, and information related to a color of the vehicle.

13. The communication system according to claim 7, wherein
a first communication apparatus is configured to manage a first area, and
in the process of receiving information related to the correspondence, the at least one processor receives information related to the correspondence from a second communication apparatus configured to manage a second area and stores the received information in the second storage section, the second communication apparatus being other than the first communication apparatus.

14. The communication system according to claim 13, wherein the at least one processor further carries out:
a process of obtaining the communication information from the second storage section based on the second feature information of the vehicle; and
a process of providing information to the vehicle based on the obtained communication information.

15. A communication method comprising:
receiving communication information and location information of a vehicle from the vehicle;
obtaining a video of the vehicle;
obtaining feature information of the vehicle based on the obtained video; and
storing, as correspondence, the obtained feature information of the vehicle and the communication information in association with each other for each vehicle, based on the communication information, the location information, and the video of the vehicle.

16. The communication method according to claim 15, wherein the communication information includes a communication mode supported by the vehicle.

17. The communication method according to claim 16, wherein the communication information includes address information of the vehicle.

18. The communication method according to claim 15, wherein the feature information of the vehicle is at least one selected from the group consisting of information related to a number plate of the vehicle, information related to a model of the vehicle, information related to a shape of the vehicle, and information related to a color of the vehicle.

19. The communication method according to claim 15, wherein
a first communication apparatus is configured to manage a first area, and
in the receiving, the method further comprises receiving information related to the correspondence from a second communication apparatus configured to manage a second area and storing the received information in the storage section, the second communication apparatus being other than the first communication apparatus.

20. The communication method according to claim 19, further comprising:
obtaining the communication information from the storage section based on the obtained feature information of the vehicle, and
providing information to the vehicle based on the obtained communication information.
